(19) United States
(12) Patent Application Publication
(10) Pub. No.: US 2016/0006787 A1
(43) Pub. Date: Jan. 7, 2016

(54) METHODS AND DEVICES FOR VISITING A WEBPAGE

(71) Applicant: Xiaomi Inc., Beijing (CN)

(72) Inventors: Shicheng WANG, Beijing (CN); Yan Xu, Beijing (CN); Daoqing Zhang, Beijing (CN)

(73) Assignee: Xiaomi Inc.

(21) Appl. No.: 14/585,677

(22) Filed: Dec. 30, 2014

Related U.S. Application Data
(63) Continuation of application No. PCT/CN2014/089187, filed on Oct. 22, 2014.

(30) Foreign Application Priority Data
Jul. 4, 2014 (CN) 201410320383.0

(51) Int. Cl. H04L 29/08; H04L 12/24

(52) U.S. Cl. CPC H04L 67/02; H04L 41/0293; H04L 67/2847

(57) ABSTRACT

A method for visiting a webpage, includes receiving, by a server, a webpage visit request from a client, the webpage visit request including at least a webpage uniform resource locator (URL) of the webpage and a last visit time point; searching, by the server, a webpage update database corresponding to the webpage according to the webpage URL, the webpage update database storing one or more update time points and webpage content information corresponding to the respective update time points; generating, by the server, a webpage update data package according to the webpage update database and the last visit time point, the webpage update data package including webpage update contents from the last visit time point to a most recent update time point; and sending, by the server, the webpage update data package to the client.

### CROSS-REFERENCE TO RELATED APPLICATIONS

This application is a continuation of International Application No. PCT/CN2014/089187, filed Oct. 22, 2014, which is based upon and claims priority to Chinese Patent Application No. 201410320383.0, filed Jul. 4, 2014, the entire contents of all of which are incorporated herein by reference.

### TECHNICAL FIELD

The present disclosure generally relates to the field of Internet and, more particularly, to methods and devices for visiting a webpage.

### BACKGROUND

As webpage contents are more and more abundant, the amount of data in webpages becomes larger and larger. Conventionally, each time a terminal retrieves contents of a webpage for a user to browse, the terminal obtains all contents of the webpage. However, due to limitations in a network, such as the 2G/3G network's speed limitation, it may take a relatively long time for the terminal to obtain all contents of the webpage.

### SUMMARY

According to a first aspect of the present disclosure, there is provide a method for visiting a webpage, comprising: receiving, by a server, a webpage visit request from a client, the webpage visit request including at least a webpage uniform resource locator (URL) of the webpage and a last visit time point; searching, by the server, a webpage update database corresponding to the webpage according to the webpage URL, the webpage update database storing one or more update time points and webpage content information corresponding to the respective update time points; generating, by the server, a webpage update data package according to the webpage update database and the last visit time point, the webpage update data package including webpage update contents from the last visit time point to a most recent update time point; and sending, by the server, the webpage update data package to the client.

According to a second aspect of present disclosure, there is provided a server, comprising: a processor; and a memory for storing instructions executable by the processor; wherein the processor is configured to: receive a webpage visit request from a client, the webpage visit request including at least a webpage uniform resource locator (URL) of a webpage and a last visit time point; search a webpage update database corresponding to the webpage according to the webpage URL, the webpage update database storing one or more update time points and webpage content information corresponding to the respective update time points; generate a webpage update data package according to the webpage update database and the last visit time point, the webpage update data package including webpage update contents from the last visit time point to a most recent update time point; and send the webpage update data package to the client.

According to a third aspect of present disclosure, there is provided a terminal, comprising: a processor; and a memory for storing instructions executable by the processor; wherein the processor is configured to: send a webpage visit request to a server, the webpage visit request including at least a webpage uniform resource locator (URL) of a webpage and a last visit time point; receive a webpage update data package returned by the server, wherein the webpage update data package is generated according to a webpage update database and the last visit time point, the webpage update database stores one or more update time points and webpage content information corresponding to the respective update time points, and the webpage update data package includes webpage update contents from the last visit time point to a most recent update time point; combine the webpage update data package with cached webpage contents of the webpage to obtain an updated webpage; and update the cached webpage contents according to the obtained updated webpage, and record a visit time point corresponding to the webpage visit request.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for visiting a webpage, according to an exemplary embodiment.

FIG. 2 is a flowchart of a method for updating a webpage update database, according to an exemplary embodiment.

FIG. 3 is a flowchart of a method for visiting a webpage, according to an exemplary embodiment.

FIG. 4 is a block diagram of a device for visiting a webpage, according to an exemplary embodiment.

FIG. 5 is a block diagram of a device for visiting a webpage, according to an exemplary embodiment.

FIG. 6 is a block diagram of a device for visiting a webpage, according to an exemplary embodiment.

FIG. 7 is a block diagram of a server, according to an exemplary embodiment.

FIG. 8 is a block diagram of a terminal, according to an exemplary embodiment.

FIGS. 9A and 9B are schematic diagrams illustrating data flows of an Internet system, according to exemplary embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

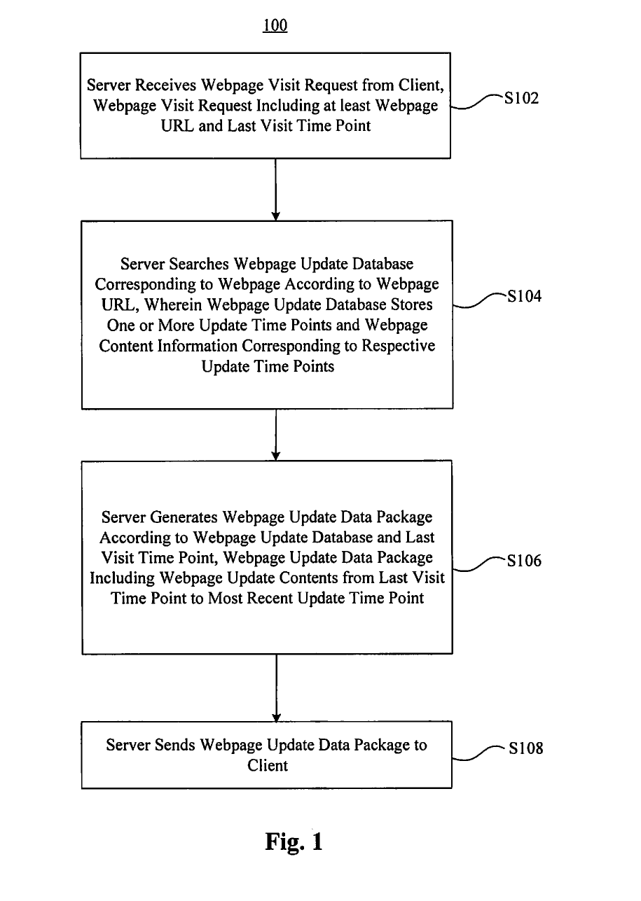

FIG. 1 is a flowchart of a method 100 for visiting a webpage, according to an exemplary embodiment. Referring to FIG. 1, the method 100 includes the following steps.

In step S102, a server receives a webpage visit request from a terminal, referred hereafter as the client, the webpage visit request including at least a webpage uniform resource locator (URL) and a last visit time point.

In step S104, the server searches a webpage update database corresponding to the webpage according to the webpage URL, wherein the webpage update database stores one or more update time points and webpage content information corresponding to the respective update time points.

In step S106, the server generates a webpage update data package according to the webpage update database and the last visit time point, the webpage update data package including webpage update contents from the last visit time point to a most recent update time point.

In step S108, the server sends the webpage update data package to the client.

In one exemplary embodiment, the server is a cloud server, which sends the webpage update contents to the client after a certain time point. The client may combine these update contents with a locally cached webpage to obtain an updated webpage.

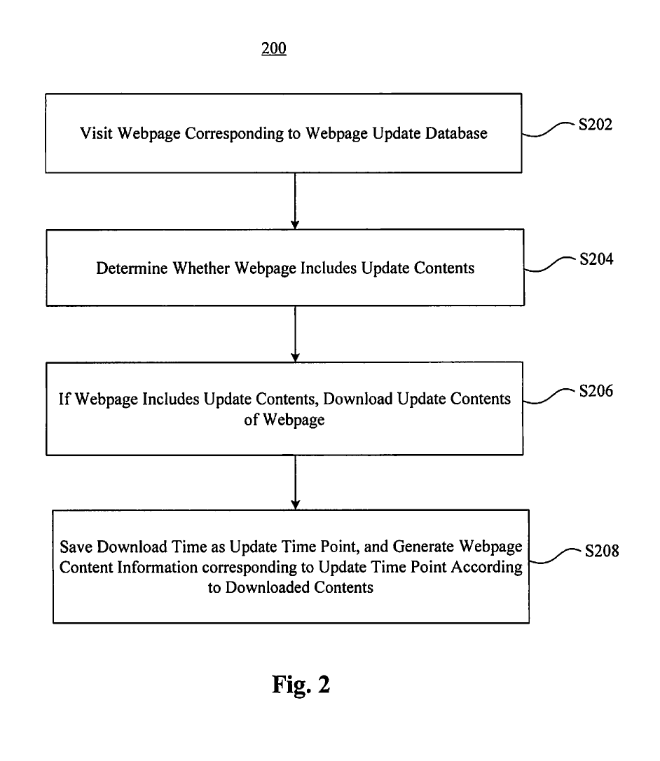

FIG. 2 is a flowchart of a method 200 for updating a webpage update database, according to an exemplary embodiment. Referring to FIG. 2, the method 200 includes the following steps.

In step S202, a webpage corresponding to the webpage update database is visited.

In step S204, it is determined whether the webpage includes any update contents.

In step S206, if the webpage includes any update contents, the update contents of the webpage are downloaded.

In step S208, a download time is saved in the webpage update database as an update time point, and webpage content information corresponding to the update time point is generated according to the downloaded webpage contents.

The present embodiment uses the database to manage webpage update data, which can increase the efficiency of data storage and retrieval.

In addition to update contents of the webpage, the database also saves webpage data of a reference time point, as well as content differences of a series of time points after the reference time point. When a browser of the client initiates a request for visiting the webpage, the request may carry information of a time point. In such case, the corresponding content differences are calculated, and the webpage is only updated with the different contents. The browser of the client may be responsible for combining and displaying the contents of the webpage. If the request does not carry information of a time point, the webpage is updated to the latest contents of the webpage.

In exemplary embodiments, the webpage update database may regularly start the update process; or the webpage update database may start the update process after receiving a webpage visit request.

Referring back to FIG. 1, step S106 may further include that: the server searches for a first update time point that is subsequently closest to the last visit time point among the update time points in the webpage update database, based on the last visit time point; and the server generates the webpage update data package, based on webpage content information corresponding to each update time point from the first update time point to a most recent update time point. In this manner, the server realizes retrieval of update contents from the webpage update database.

In one exemplary embodiment, the server performs statistics on a number of visits to the webpage based on webpage visit requests; if the number of visits to the webpage is lower than a first threshold value in a predetermined time period, the server deletes the webpage update database corresponding to the webpage; and if the number of visits to the webpage is higher than a second threshold value in the predetermined time period and there is no webpage update database corresponding to the webpage, the server creates a webpage update database. This embodiment enables updating webpage update databases of the respective webpages that are frequently visited by users, thereby the workload of updating the databases is reduced.

In one exemplary embodiment, when the webpage visit request does not include a last visit time point, the server uses the webpage URL in the request to locate an item in the webpage update database corresponding to the webpage. The server also obtains a most recent update time point and the corresponding webpage content information from the item in the webpage update database, and sends the most recent update time point and the corresponding webpage content information to the client.

In exemplary embodiments, the user may visit a website that the user has not visited before. Thus, the client has neither cached any data of the website, nor had any last visit time point. Accordingly, the server directly provides the client with the webpage content information and a corresponding time point. This way, when the client visits the webpage next time, the visit speed can be improved.

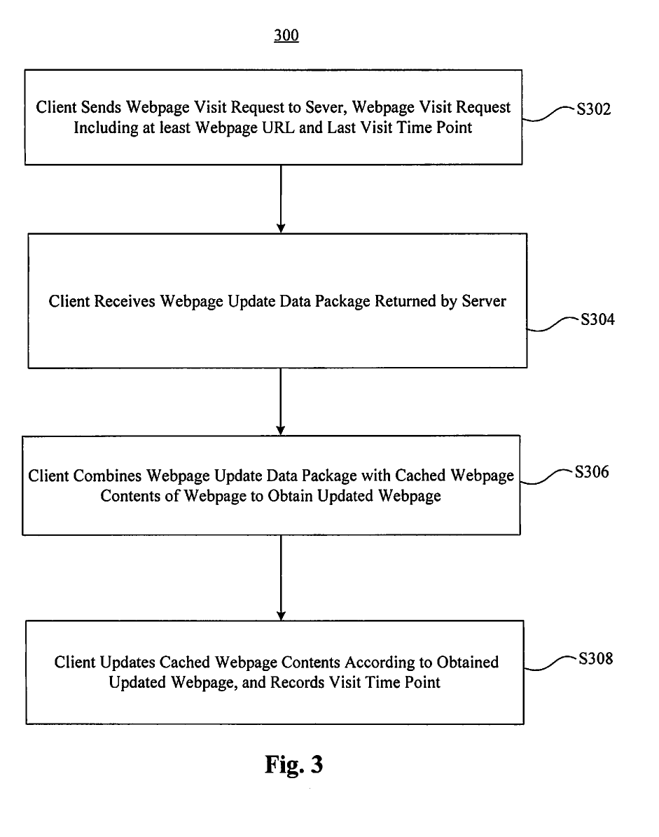

FIG. 3 is a flowchart of a method 300 for visiting a webpage, according to an exemplary embodiment. Referring to FIG. 3, the method 300 includes the following steps.

In step S302, a client sends a webpage visit request to a server, the webpage visit request including at least a webpage URL and a last visit time point.

In step S304, the client receives a webpage update data package returned by the server, wherein the webpage update data package is generated according to a webpage update database and the last visit time point. The webpage update database stores one or more update time points and webpage content information corresponding to the respective update time points, and the webpage update data package includes webpage update contents from the last visit time point to a most recent update time point.

In step S306, the client combines the webpage update data package with cached webpage contents of the webpage to obtain an updated webpage.

In step S308, the client updates the cached webpage contents according to the obtained updated webpage, and records a visit time point corresponding to the webpage visit request.

Based on the method 300, the server only sends the webpage update contents after a certain time point to the client, and the client combines these update contents with the locally cached webpage to obtain the updated webpage. When the user browses a frequently visited website, the method 300 only needs to send updated contents of the webpage instead of contents of the entire webpage, which reduces an amount of data transmitted. Thus, the visit speed may be increased, and user experience may be improved.

In one exemplary embodiments, step S306 may further include that: according to an increment resource in the webpage update data package, the client adds the increment resource into the cached webpage contents of the webpage; according to a substitution resource in the webpage update data package, the client substitutes a corresponding resource in the cached webpage contents of the webpage with the substitution resource; and according to a deletion resource in the webpage update data package, the client deletes a corresponding resource in the cached webpage contents of the webpage. The present embodiment provides the editing methods of increment, substitution and deletion, to efficiently provide the client with update contents of the webpage.

In one exemplary embodiment, when the client determines that there are no cached content of the webpage and no corresponding time point, the client sends a webpage visit request to the server that does not include a time point. The client receives from the server a most recent update time point and corresponding webpage contents, and then generates a webpage based on the corresponding webpage content information. The client also caches the webpage contents and the most recent update time point. In one exemplary embodiment, the user may visit a website that the user has not visited before. Accordingly, the server directly provides the client with webpage contents and a corresponding time point. As a result, the visit speed can be improved when the client visits the webpage next time.

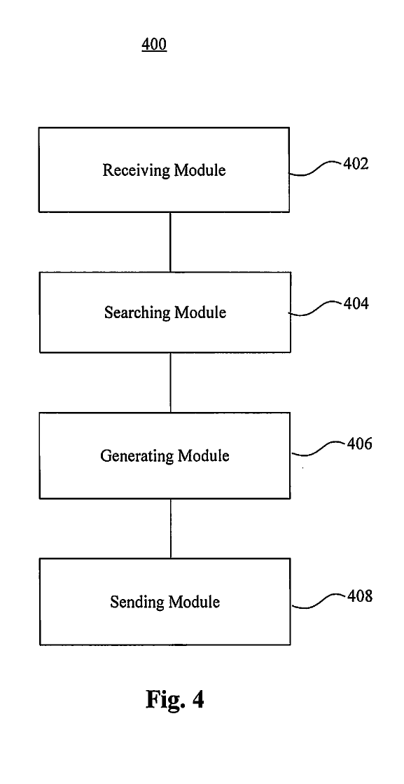

FIG. 4 is a block diagram of a device 400 for visiting a webpage, according to an exemplary embodiment. Referring to FIG. 4, the device 400 includes a receiving module 402, a searching module 404, a generating module 406, and a sending module 408. The receiving module 402 is configured to receive a webpage visit request from a client, the webpage visit request including at least a webpage URL and a last visit time point. The searching module 404 is configured to search a webpage update database corresponding to the webpage according to the webpage URL, the webpage update database storing one or more update time points and webpage content information corresponding to the respective update time points. The generating module 406 is configured to generate a webpage update data package according to the webpage update database and the last visit time point, the webpage update data package including webpage update contents from the last visit time point to a most recent update time point. The sending module 408 is configured to send the webpage update data package to the client. In exemplary embodiments, the device 400 sends the webpage update contents after a certain time point to the client, and the client may combine these update contents with the locally cached webpage to obtain an updated webpage.

In exemplary embodiments, the device 400 may further include an updating module configured to update the webpage update database. The updating module visits a webpage corresponding to the webpage update database, and judges whether the webpage includes update contents. If the webpage includes update contents, the updating module downloads the update contents of the webpage, saves a download time as an update time point in the webpage update database, and generates webpage content information corresponding to the update time point according to the downloaded contents.

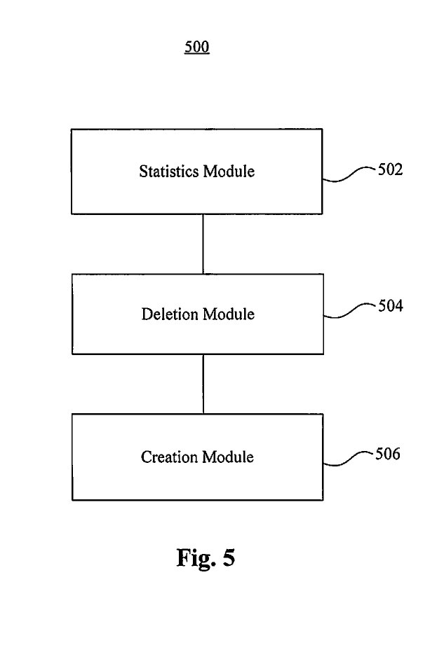

FIG. 5 is a block diagram of a device 500 for visiting a webpage, according to an exemplary embodiment. The device 500 includes a statistics module 502, a deletion module 504, and a creation module 506. The statistics module 502 is configured to perform statistics on a number of visits to the webpage based on webpage visit requests. The deletion module 504 is configured to delete the webpage update database corresponding to the webpage if the number of visits to the webpage is lower than a first threshold value in a predetermined time period. The creation module 506 is configured to create a webpage update database corresponding to the webpage if the number of visits to the webpage is higher than a second threshold value in the predetermined time period and there is no webpage update database corresponding to the webpage. This embodiment enables updating webpage update databases of the respective webpages that are frequently visited by users, thereby the workload of updating the webpage update databases is reduced.

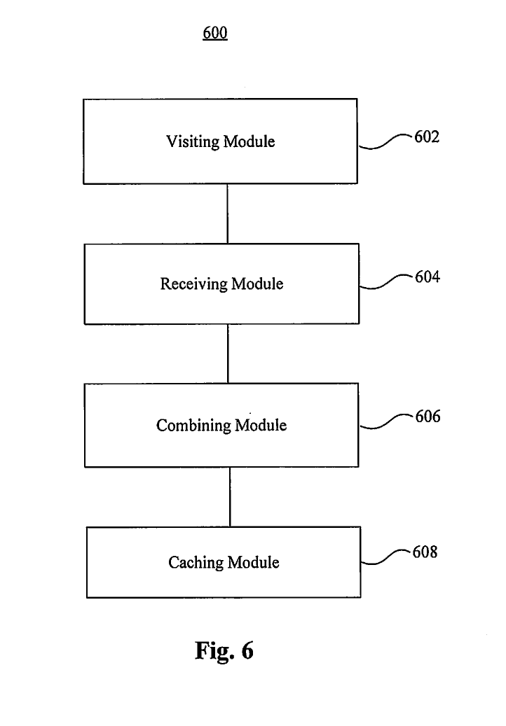

FIG. 6 is a block diagram of a device 600 for visiting a webpage, according to an exemplary embodiment. Referring to FIG. 6, the device 600 includes a visiting module 602, a receiving module 604, a combining module 606, and a caching module 608. The visiting module 602 is configured to send a webpage visit request to a server, the webpage visit request including at least a webpage URL and a last visit time point. The receiving module 604 is configured to receive a webpage update data package sent by the server, the webpage update data package including webpage update contents from the last visit time point to a most recent update time point. The combining module 606 is configured to combine the webpage update data package with locally cached webpage contents of the webpage to obtain an updated webpage. The caching module 608 is configured to update the cached webpage contents based on the obtained updated webpage, and to record a visit time point. In the illustrated embodiment, the server only sends the webpage update contents to the client after a certain time point, and the client combines these update contents with the locally cached webpage to obtain the updated webpage. When the user browses a frequently visited website, the server only needs to send updated contents of the webpage instead of the entire webpage, which reduces the amount of data transmitted. Thus, the visit speed may be increased, and user experience may be improved.

In one exemplary embodiment, the combining module 606 may include an increment unit, a substitution unit, and a deletion unit (not shown). The increment unit is configured to add, according to an increment resource in the webpage update data package, the increment resource into the cached webpage contents of the webpage. The substitution unit is configured to substitute, according to a substitution resource in the webpage update data package, a corresponding resource in the cached webpage contents of the webpage with the substitution resource. The deletion unit is configured to delete, according to a deletion resource in the webpage update data package, a corresponding resource in the cached webpage contents of the webpage. The present embodiment provides the editing methods of increment, substitution and deletion, to efficiently provide the client with update contents of the webpage.

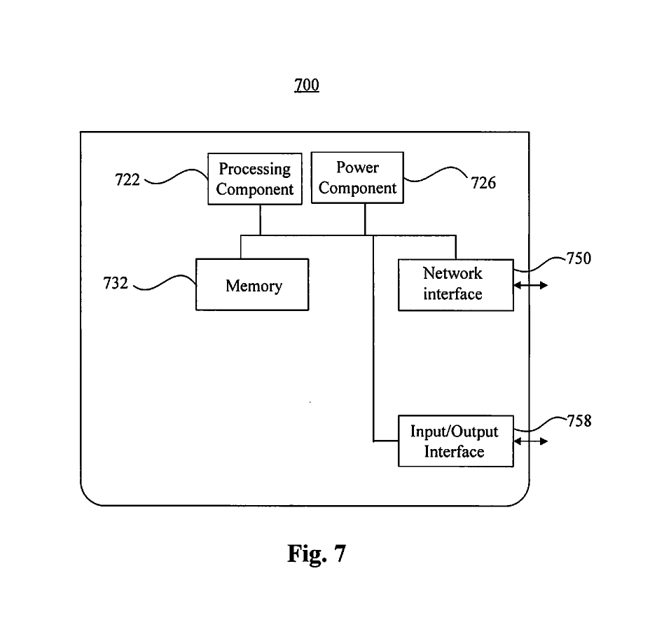

FIG. 7 is a block diagram of a server 700, according to an exemplary embodiment. The server 700 includes a processing component 722 that further includes one or more processors, and a memory 732 for storing instructions executable by the processing component 722, such as application programs. The application programs stored in the memory 732 may include one or more modules each corresponding to a set of instructions. Further, the processing component 722 is configured to execute the instructions for performing the methods 100 (FIG. 1) and 200 (FIG. 2).

The server 700 may further include one or more power components 726 configured to perform power management of the server 700; one or more wired or wireless network interfaces 750 configured to connect the server 700 to a network; one or more input/output (I/O) interfaces 758; and/or one or more keyboards (not shown). The server 700 may operate based on an operating system stored in the memory 732, such as Windows Server™, Mac OS X™, Unix™, Linux™, FreeBSD™, or the like.

In exemplary embodiments, there is also provided a non-transitory computer readable storage medium including instructions, such as included in the memory 732, executable by the processing component 722 in the server 700, to perform the above-described methods. For example, the non-transitory computer-readable storage medium may be a ROM, a random access memory (RAM), a CD-ROM, a magnetic tape, a floppy disc, an optical data storage device and the like.

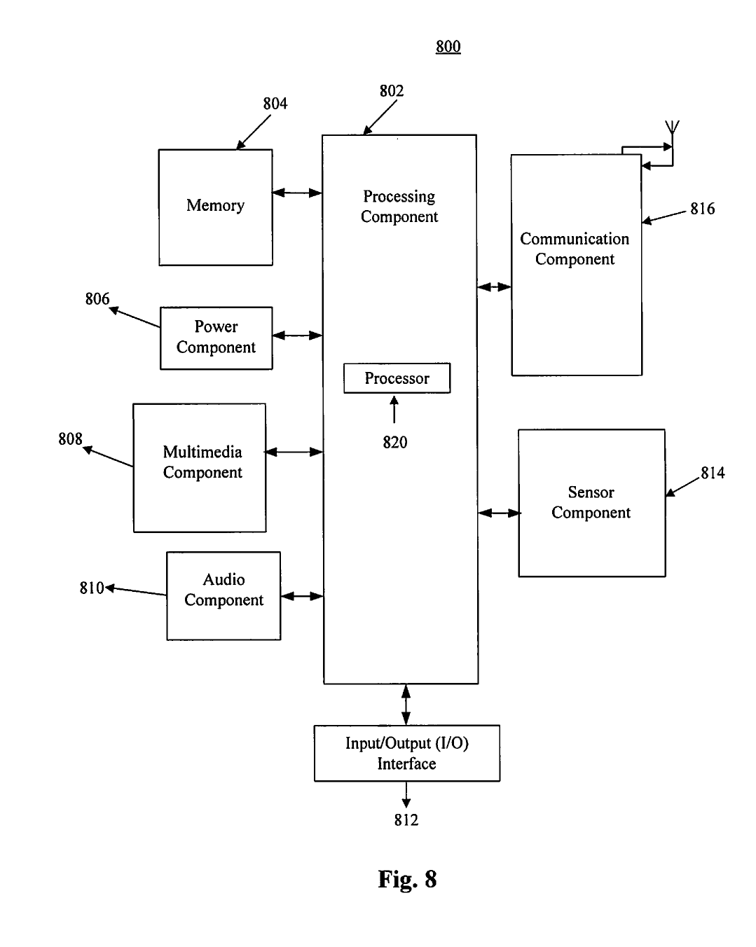

FIG. 8 is a block diagram of a client 800, according to an exemplary embodiment. For example, the client 800 may be a mobile phone, a computer, a digital broadcast terminal, a messaging device, a gaming console, a tablet, a medical device, exercise equipment, a personal digital assistant, and the like.

Referring to FIG. 8, the client 800 may include one or more of the following components: a processing component 802, a memory 804, a power component 806, a multimedia component 808, an audio component 810, an input/output (I/O) interface 812, a sensor component 814, and a communication component 816.

The processing component 802 controls overall operations of the client 800, such as operations associated with display, telephone calls, data communications, camera operations and recording operations. The processing component 802 may include one or more processors 820 to execute instructions to perform all or a part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802. The processing component 802 is configured to execute instructions for performing the method 300 (FIG. 3).

The memory 804 is configured to store various types of data to support the operation of the client 800. Examples of such data include instructions for any application or method operated on the client 800, contact data, phonebook data, messages, pictures, videos, etc. The memory 804 may be implemented by any type of volatile or non-volatile memory device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or optical disk.

The power component 806 provides power to various components of the client 800. The power component 806 may include a power management system, one or more power sources, and other components associated with generating, managing, and distributing power for the client 800.

The multimedia component 808 includes a screen for providing an output interface between the client 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 808 includes a front camera and/or a rear camera. The front camera and/or the rear camera may receive external multimedia data while the client 800 is in an operation mode, such as a photographing mode or a video mode. Each of the front camera and the rear camera may be a fixed optical lens system or may have focus and optical zoom capability.

The audio component 810 is configured to output and/or input audio signals. For example, the audio component 810 includes a microphone configured to receive an external audio signal when the client 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, a button, and the like. The button may include, but not limited to: a home button, a volume button, a starting button and a locking button.

The sensor component 814 includes one or more sensors to provide status assessments of various aspects of the client 800. For instance, the sensor component 814 may detect open/close statuses of the client 800 and relative positions of components of the client 800, such as the display and the keyboard. The sensor component 814 may also detect position changes of the client 800 or its components, presence or absence of user contacts with the client 800, orientation or acceleration/deceleration of the client 800, and temperature changes of the client 800. The sensor component 814 may further include a proximity sensor configured to detect the presence of nearby objects without any physical contact. Moreover, the sensor component 814 may include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the client 800 and other devices. The client 800 can access a wireless network based on a communication standard, such as WiFi, 2G, 3G, or a combination thereof. In one exemplary embodiment, the communication component 816 receives a broadcast signal or broadcast related information from an external broadcast management system via a broadcast channel. In another exemplary embodiment, the communication component 816 further includes a near-field communication (NFC) module to facilitate short-range communications. The NFC module, for example, may be implemented based on a radio frequency identification (RFID) technology, an infrared data association (IrDA) technology, an ultra-bandwidth (UWB) technology, a Bluetooth (BT) technology, and other technologies.

In the exemplary embodiments, the client 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components.

In exemplary embodiments, there is also provided a non-transitory computer readable storage medium including instructions, such as included in the memory 804, executable by the processor 820 in the client 800, to perform the above-described methods. For example, the non-transitory computer-readable storage medium may be a ROM, a random access memory (RAM), a CD-ROM, a magnetic tape, a floppy disc, an optical data storage device and the like.

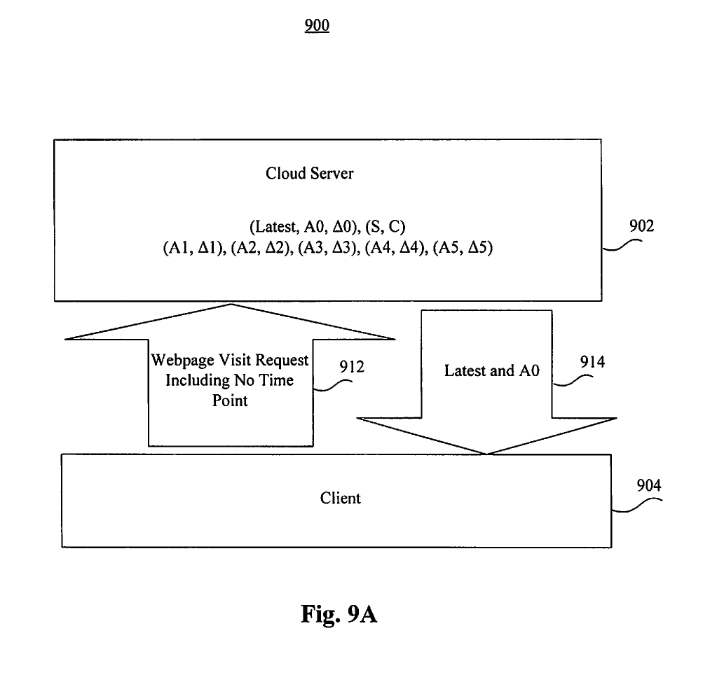

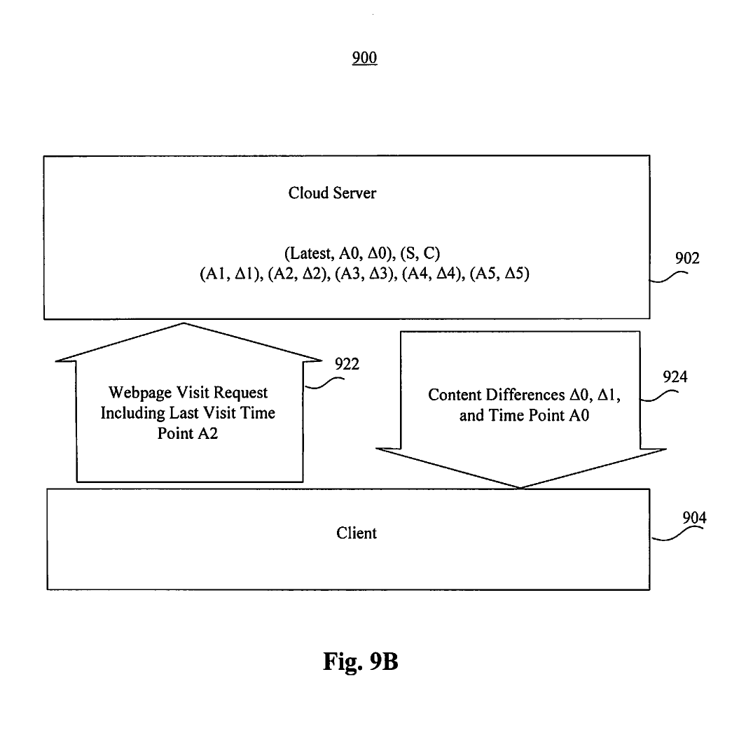

FIGS. 9A and 9B are schematic diagrams of data flows of an Internet system 900, according to exemplary embodiments. Referring to FIGS. 9A and 9B, the system 900 includes a cloud server 902 and a client 904. The cloud server 902 is configured to perform the methods 100 (FIG. 1) and 200 (FIG. 2), and the client 904 is configured to perform the method 300 (FIG. 3). For example, the cloud server 902 saves latest contents (Latest) of a webpage, a content difference (Δ0) between a reference time point (S) and a latest update time point (A0), contents (C) of the webpage at the reference time point (S), as well as content updates, e.g., Δ1, Δ2, Δ3, Δ4, and Δ5 at a series of time points A1, A2, A3, A4, and A5, respectively, which can be expressed as (A1, Δ1), (A2, Δ2), (A3, Δ3), (A4, Δ4), and (A5, Δ5).

In one exemplary embodiment, shown in FIG. 9A, the client 904 sends a webpage visit request 912 to the cloud server 902, the webpage visit request 912 including no time point. Accordingly, the cloud server 902 sends a response 914 to the client 904, the response 914 including the latest contents (Latest) and the latest update time point (A0).

In one exemplary embodiment, shown in FIG. 9B, the client 904 sends a webpage visit request 922 to the cloud server 902, the webpage visit request 922 including a last visit time point (A2). Accordingly, the cloud server 902 sends a response 924 to the client 904, the response 924 including the content updates Δ0, Δ1, and the lasted update time point A0. As a result, the client 904 determines the contents of the webpage at the lasted update time point A0 based on the content updates Δ0, Δ1, and the client's locally cached contents of the webpage at the last visit time point A2.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for visiting a webpage, comprising:
receiving, by a server, a webpage visit request from a client, the webpage visit request including at least a webpage uniform resource locator (URL) of the webpage and a last visit time point;
searching, by the server, a webpage update database corresponding to the webpage according to the webpage URL, the webpage update database storing one or more update time points and webpage content information corresponding to the respective update time points;
generating, by the server, a webpage update data package according to the webpage update database and the last visit time point, the webpage update data package including webpage update contents from the last visit time point to a most recent update time point; and
sending, by the server, the webpage update data package to the client.

2. The method according to claim 1, further comprising updating the webpage update database in an update process, including:
visiting a webpage corresponding to the webpage update database;
judging whether the webpage includes update contents based on the visiting;
if the webpage includes update contents, downloading the update contents of the webpage, and saving a download time as an update time point in the webpage update database; and
generating webpage content information corresponding to the update time point according to the downloaded contents of the webpage.

3. The method according to claim 2, wherein the webpage update database regularly starts the update process of the webpage update database.

4. The method according to claim 2, wherein the webpage update database starts the update process of the webpage update database after the webpage visit request is received.

5. The method according to claim 1, wherein the generating of the webpage update data package comprises:
searching for a first update time point that is subsequently closest to the last visit time point among the update time points in the webpage update database, based on the last visit time point; and
generating the webpage update data package based on the webpage content information corresponding to the respective update time points from the first update time point to the most recent update time point.

6. The method according to claim 1, wherein the webpage is a first webpage, the method further comprising:
performing statistics on a number of visits to a second webpage based on a plurality of webpage visit requests;
if the number of visits to the second webpage is lower than a first threshold value in a predetermined time period, deleting a webpage update database corresponding to the second webpage; and
if the number of visits to the second webpage is higher than a second threshold value in the predetermined time period and there is no webpage update database corresponding to the second webpage, creating a webpage update database corresponding to the second webpage.

7. The method according to claim 1, wherein the client:
sends the webpage visit request to the server;
receives the webpage update data package sent by the server;
combines the webpage update data package with cached webpage contents of the webpage to obtain an updated webpage; and
updates the cached webpage contents according to the obtained updated webpage, and records a visit time point corresponding to the webpage visit request.

8. The method according to claim 7, wherein the combining of the webpage update data package with the cached webpage contents of the webpage to obtain the updated webpage comprises:
according to an increment resource in the webpage update data package, adding the increment resource into the cached webpage contents of the webpage;
according to a substitution resource in the webpage update data package, substituting a corresponding resource in the cached webpage contents of the webpage with the substitution resource; and
according to a deletion resource in the webpage update data package, deleting a corresponding resource from the cached webpage contents of the webpage.

9. A server, comprising:
a processor; and
a memory for storing instructions executable by the processor;
wherein the processor is configured to:
receive a webpage visit request from a client, the webpage visit request including at least a webpage uniform resource locator (URL) of a webpage and a last visit time point;
search a webpage update database corresponding to the webpage according to the webpage URL, the webpage update database storing one or more update time points and webpage content information corresponding to the respective update time points;
generate a webpage update data package according to the webpage update database and the last visit time point, the webpage update data package including webpage update contents from the last visit time point to a most recent update time point; and
send the webpage update data package to the client.

10. The server according to claim 9, wherein the processor is further configured to update the webpage update database, comprising:
visiting the webpage corresponding to the webpage update database;
judging whether the webpage includes update contents based on the visiting; and
if the webpage includes update contents, downloading the update contents of the webpage, saving a download time as an update time point, and generating webpage content information corresponding to the update time point according to the downloaded contents of the webpage.

11. The server according to claim 9, wherein the webpage is a first webpage, the processor being further configured to:
perform statistics on a number of visits to a second webpage based on a plurality of webpage visit requests;
delete a webpage update database corresponding to the second webpage if the number of visits to the second webpage is lower than a first threshold value in a predetermined time period; and
create a webpage update database corresponding to the second webpage if the number of visits to the second webpage is higher than a second threshold value in the predetermined time period and there is no webpage update database corresponding to the second webpage.

12. A terminal, comprising:
a processor; and
a memory for storing instructions executable by the processor;
wherein the processor is configured to:
send a webpage visit request to a server, the webpage visit request including at least a webpage uniform resource locator (URL) of a webpage and a last visit time point;
receive a webpage update data package returned by the server, wherein the webpage update data package is generated according to a webpage update database and the last visit time point, the webpage update database stores one or more update time points and webpage content information corresponding to the respective update time points, and the webpage update data package includes webpage update contents from the last visit time point to a most recent update time point;
combine the webpage update data package with cached webpage contents of the webpage to obtain an updated webpage; and
update the cached webpage contents according to the obtained updated webpage, and record a visit time point corresponding to the webpage visit request.

13. The terminal according to claim 12, wherein the processor is further configured to:
according to an increment resource in the webpage update data package, add the increment resource into the cached webpage contents of the webpage;
according to a substitution resource in the webpage update data package, substitute a corresponding resource in the cached webpage contents of the webpage with the substitution resource; and
according to a deletion resource in the webpage update data package, delete a corresponding resource from the cached webpage contents of the webpage.
